(19) United States
(12) Patent Application Publication
(10) Pub. No.: US 2026/0135039 A1
(43) Pub. Date: May 14, 2026

(54) MULTILAYER CERAMIC CAPACITOR

(71) Applicant: Murata Manufacturing Co., Ltd., Nagaokakyo-shi (JP)

(72) Inventor: Keisuke NAKANO, Nagaokakyo-shi (JP)

(21) Appl. No.: 19/362,548

(22) Filed: Oct. 20, 2025

(30) Foreign Application Priority Data
Nov. 13, 2024 (JP) 2024-198181

(51) Int. Cl. H01G 4/232; H01G 4/005; H01G 4/12; H01G 4/248; H01G 4/30

(52) U.S. Cl. CPC H01G 4/2325; H01G 4/005; H01G 4/12; H01G 4/248; H01G 4/30

(57) ABSTRACT

In a multilayer ceramic capacitor, in a cross section parallel to a longitudinal direction and a lamination direction at a width-direction center, a dimension of an inner layer portion in the longitudinal direction is larger than a dimension of outer layer portions in the longitudinal direction. In the cross section, a dimension of the inner layer portion in the longitudinal direction at a lamination-direction center is larger than a dimension of the inner layer portion in the longitudinal direction at each lamination direction end portion. The multilayer ceramic capacitor includes recesses at or adjacent to boundaries between the outer layer portions and the inner layer portion on a first end surface or a second end surface, the recesses being recessed from the inner layer portion and the outer layer portions.

### CROSS REFERENCE TO RELATED APPLICATIONS

This application claims the benefit of priority to Japanese Patent Application No. 2024-198181 filed on Nov. 13, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are one of the important components included in electronic devices. Hence, multilayer ceramic capacitors with high reliability are required in the market. Japanese Unexamined Patent Application Publication No. 2007-142118 discloses a multilayer ceramic capacitor with a low failure rate.

### SUMMARY OF THE INVENTION

However, since the thickness of the outer electrodes typically decreases toward the corner portions of the inner layer portion, in other words, toward the end portions in the lamination direction. Hence, in the multilayer ceramic capacitor in which the inner layer portion protrudes, as in Japanese Unexamined Patent Application Publication No. 2007-142118, the distance from the outer-electrode surfaces to the portions of the inner electrode layers exposed on the end surfaces tends to be short for inner electrode layers close to the main surfaces. Hence, in conventional multilayer ceramic capacitors, the reliability in moisture resistance is low at the corner portions of the inner layer portion, increasing its failure rate in some cases.

Hence, example embodiments of the present invention provide multilayer ceramic capacitors each with a low failure rate.

A multilayer ceramic capacitor of the present invention includes a multilayer body including an inner layer portion including dielectric layers and inner electrode layers laminated in a lamination direction and outer layer portions located on both sides of the inner layer portion in the lamination direction, the multilayer body including first and second main surfaces opposed to each other in the lamination direction, first and second side surfaces opposed to each other in a width direction orthogonal to the lamination direction, and first and second end surfaces opposed to each other in a longitudinal direction orthogonal to the lamination direction and the width direction, and outer electrodes located on the first and second end surfaces and coupled to the inner electrode layers, in a cross section parallel to the longitudinal direction and the lamination direction at a center in the width direction, a dimension of the inner layer portion in the longitudinal direction is larger than a dimension of each of the outer layer portions in the longitudinal direction, in the cross section parallel to the longitudinal direction and the lamination direction at the center in the width direction, a dimension of the inner layer portion in the longitudinal direction at a center in the lamination direction is larger than a dimension of the inner layer portion in the longitudinal direction at each end portion in the lamination direction, and the multilayer ceramic capacitor includes recesses at or adjacent to boundaries between the outer layer portions and the inner layer portion on the first or second end surface, the recesses being recessed from the inner layer portion and the outer layer portions.

With example embodiments of the present invention, it is possible to provide multilayer ceramic capacitors each with a low failure rate.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of the external appearance of a multilayer ceramic capacitor according to an example embodiment of the present invention.

FIG. 2 is a cross-sectional view taken along line 101-101 in FIG. 1.

FIG. 3 is a cross-sectional view taken along line 102-102 in FIG. 1.

FIG. 4 is a cross-sectional view taken along line 103-103 in FIG. 1.

FIG. 5 is a diagram corresponding to the cross-sectional view taken along line 101-101 in FIG. 1.

FIG. 6 is an enlarged view of the framed area 220 in FIG. 5.

FIG. 7 is a diagram corresponding to the cross-sectional view taken along line 101-101 in FIG. 1.

### DETAILED DESCRIPTION OF THE EXAMPLE EMBODIMENTS

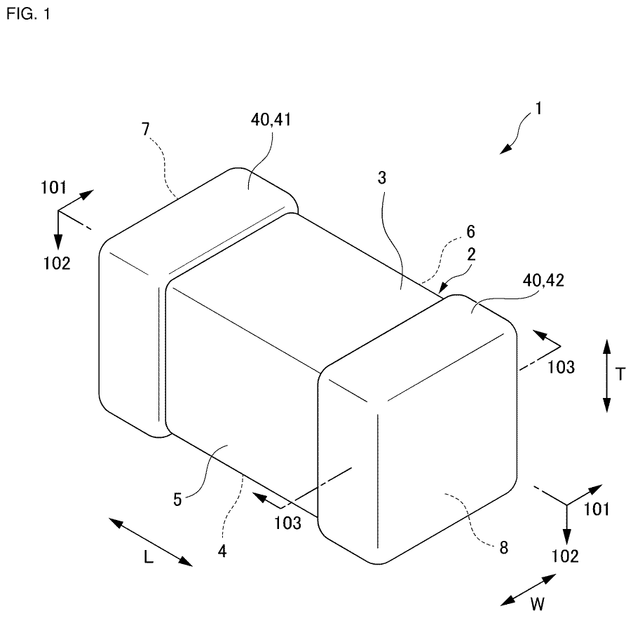

Multilayer ceramic capacitors according to example embodiments of the present disclosure will be described with reference to the drawings. FIG. 1 is a perspective view of an external appearance of a multilayer ceramic capacitor 1 according to an example embodiment of the present disclosure.

As illustrated in FIG. 1, the multilayer ceramic capacitor 1 has an approximately rectangular parallelepiped shape. The multilayer ceramic capacitor 1 includes a multilayer body 2 and outer electrodes 40. The multilayer body 2 has an approximately rectangular parallelepiped shape.

The outer electrodes 40 include a first outer electrode 41 and a second outer electrode 42. The outer electrodes 40 are located at two end portions of the multilayer body 2 and are spaced apart from each other. An outer electrode 40 located at one end portion is the first outer electrode 41. The outer electrode 40 located at the other end portion is the second outer electrode 42.

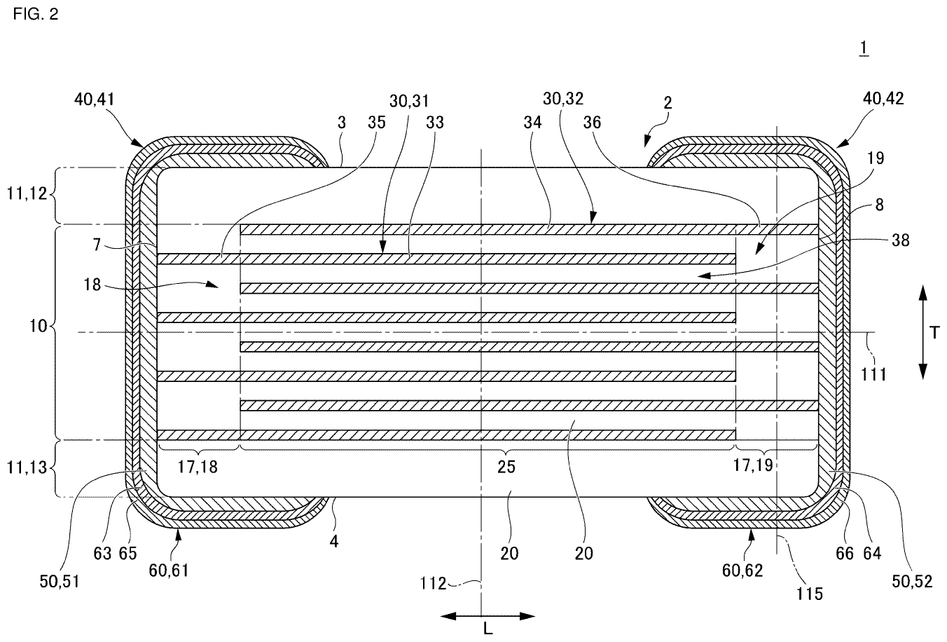

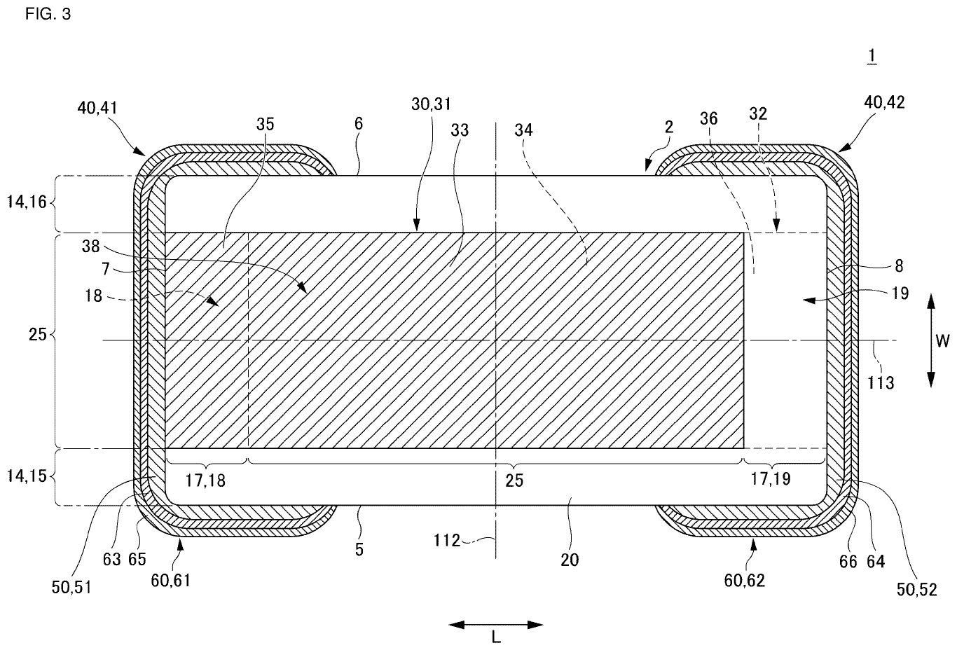

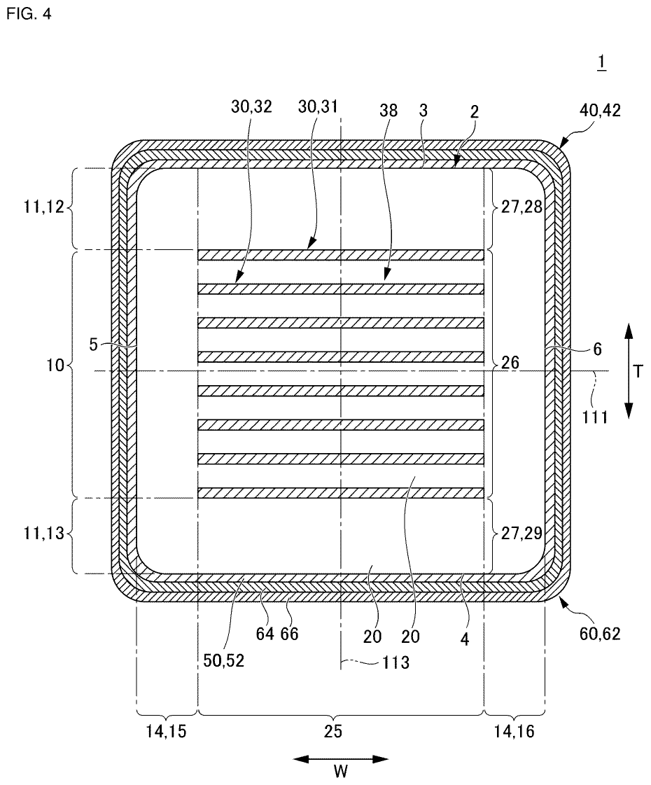

The multilayer body 2 will be described with reference to FIGS. 2, 3, and 4, in addition to FIG. 1. FIG. 2 is a cross-sectional view taken along line 101-101 in FIG. 1. FIG. 3 is a cross-sectional view taken along line 102-102 in FIG. 1. FIG. 3 illustrates a first inner electrode layer 31. FIG. 4 is a cross-sectional view taken along line 103-103 in FIG. 1.

As illustrated in FIG. 2, the multilayer body 2 includes dielectric layers 20 and inner electrode layers 30. The plurality of dielectric layers 20 and the plurality of inner electrode layers 30 are laminated on top of one another. The inner electrode layers 30 include first inner electrode layers 31 and second inner electrode layers 32.

Directions related to the multilayer ceramic capacitor 1 and the multilayer body 2 will be described. As illustrated in FIG. 2, the direction in which the dielectric layers 20 and the inner electrode layers 30 are laminated is defined as the lamination direction T. In the multilayer ceramic capacitor 1, the direction that intersects the lamination direction T and in which the first outer electrode 41 and the second outer electrode 42 are opposed to each other is defined as the longitudinal direction L. The direction intersecting both the lamination direction T and the longitudinal direction L is defined as the width direction W.

In the present example embodiment, the lamination direction T, the longitudinal direction L, and the width direction W are orthogonal to one another. The lamination direction T, the longitudinal direction L, and the width direction W indicate the same directions as the above-mentioned directions also in the figures other than FIG. 2.

The two surfaces of the multilayer body 2 opposed to each other in the lamination direction T are defined as the first main surface 3 and the second main surface 4. The two surfaces of the multilayer body 2 opposed to each other in the width direction W are defined as the first side surface 5 and the second side surface 6. The two surfaces of the multilayer body 2 opposed to each other in the longitudinal direction L are defined as the first end surface 7 and the second end surface 8.

Each portion at which two surfaces of the multilayer body 2 intersect each other is defined as a ridge line portion. Each portion at which three surfaces of the multilayer body 2 intersect one another is defined as a vertex portion. It is preferable that the vertex portions and the ridge line portions be rounded. The rectangular parallelepiped shape of the multilayer body 2 includes ones with rounded ridge line portions and rounded vertex portions. The multilayer body 2 having a rectangular parallelepiped shape includes all the structures including the first main surface 3, the second main surface 4, the first side surface 5, the second side surface 6, the first end surface 7, and the second end surface 8. Note that some or all of the main surfaces, the side surfaces, and the end surfaces may include irregularities.

As illustrated in FIG. 2, the center position in the multilayer body 2 in the lamination direction T is defined as the lamination-direction center 111. The center position in the multilayer body 2 in the longitudinal direction L is defined as the longitudinal-direction center 112. The center position in the multilayer body 2 in the width direction W is defined as the width-direction center 113.

It is preferable that the total number of dielectric layers 20 included in the multilayer body 2 be 15 or more and 1800 or less, for example.

Examples of the ceramic material included in the dielectric layers 20 include dielectric ceramics including BaTiO₃, CaTiO₃, SrTiO₃, CaZrO₃, or the like as the main component. The ceramic material may include not only the main component mentioned above but also a minor component such as Mg, Mn, Si, Ni, Fe, Cr, Co, or the like or a compound including one of these elements.

Each dielectric layer 20 preferably has a thickness of, for example, about 0.5 μm or more and about 30 μm or less, for example.

The dimensions of the multilayer body 2 are not particularly limited. The dimension of the multilayer body 2 in the longitudinal direction L may be, for example, about 0.2 mm or more and about 4.0 mm or less. The dimension of the multilayer body 2 in the width direction W may be, for example, about 0.1 mm or more and about 3.0 mm or less. The dimension of the multilayer body 2 in the lamination direction T may be, for example, about 0.1 mm or more and about 3.0 mm or less.

The inner electrode layers 30 will be described. As described earlier, the inner electrode layers 30 include the plurality of first inner electrode layers 31 and the plurality of second inner electrode layers 32. The inner electrode layers 30 exposed on the first end surface 7 are defined as the first inner electrode layers 31. The inner electrode layers 30 exposed on the second end surface 8 are defined as the second inner electrode layers 32. The end portions of the first inner electrode layers 31 and the second inner electrode layers 32, extended to the surfaces of the multilayer body 2, specifically, the end surfaces of the multilayer body 2, are defined as the exposed portions.

Specifically, the first inner electrode layers 31 are exposed on the first end surface 7 and not exposed on the first main surface 3, the second main surface 4, the first side surface 5, the second side surface 6, and the second end surface 8. The second inner electrode layers 32 are exposed on the second end surface 8 and not exposed on the first main surface 3, the second main surface 4, the first side surface 5, the second side surface 6, and the first end surface 7.

Specifically, end portions of the first inner electrode layers 31 and the second inner electrode layers 32 may be located at position slightly recessed from the first end surface 7 or the second end surface 8.

Inside the multilayer body 2, the plurality of first inner electrode layers 31 and the plurality of second inner electrode layers 32, each having an approximately rectangular shape, are alternately arranged at equal or substantially equal intervals in the lamination direction T. Each of the first inner electrode layers 31 and each of the second inner electrode layers 32 are approximately parallel to the first main surface 3 and the second main surface 4. Each first inner electrode layer 31 and each second inner electrode layer 32 face each other in the lamination direction T with a dielectric layer 20 interposed therebetween.

Each first inner electrode layer 31 includes a first facing portion 33 and a first extended portion 35. The portion of each first inner electrode layer 31 facing a second inner electrode layer 32 is defined as the first facing portion 33. The portion of the first inner electrode layer 31 extended from the first facing portion 33 to the first end surface 7 is defined as the first extended portion 35. Similarly, each second inner electrode layer 32 includes a second facing portion 34 and a second extended portion 36. The portion of each second inner electrode layer 32 facing a first inner electrode layer 31 is defined as the second facing portion 34. The portion of the second inner electrode layer 32 extended from the second facing portion 34 to the second end surface 8 is defined as the second extended portion 36.

The shape of the first facing portion 33 is not particularly limited. It is preferable that the first facing portion 33 has a rectangular or substantially rectangular shape. The corner portions of the first facing portion 33 may be rounded, and the corner portions of the first facing portion 33 may be oblique so as to be tapered. Similarly, the shape of the second facing portion 34 is not particularly limited. It is preferable that the second facing portion 34 have a rectangular or substantially rectangular shape. The corner portions of the second facing portion 34 may be rounded, and the corner portions of the second facing portion 34 may be oblique so as to be tapered. The taper shape may have an inclination in thickness as it extends toward an end.

The shape of the first extended portion 35 is not particularly limited. It is preferable that the first extended portion 35 have a rectangular or substantially rectangular shape. The corner portions of the first extended portion 35 may be rounded, and the corner portions of the first extended portion 35 may be oblique so as to be tapered. Similarly, the shape of the second extended portion 36 is not particularly limited. It is preferable that the second extended portion 36 have a rectangular or substantially rectangular shape. The corner portions of the second extended portion 36 may be rounded, and the corner portions of the second extended portion 36 may be oblique so as to be tapered. The taper shape may have an inclination in thickness as it extends toward an end.

The corner portions mean the portions located at the corners of the outer shape of an inner electrode layer 30 in a cross-sectional view of the inner electrode layer 30 parallel to the longitudinal direction L and the width direction W.

The width of the first facing portion 33 in the width direction W and the width of the first extended portion 35 in the width direction W may be the same, or one of them may be smaller than the other. The width of the second facing portion 34 in the width direction W and the width of the second extended portion 36 in the width direction W may be the same, or one of them may be smaller than the other.

The inner electrode layers 30 include at least Cu among Ni, Cu, Ag, Pd, an Ag—Pd alloy, and Au. The main component of the inner electrode layers 30 may be Cu.

The metal included in the inner electrode layers 30 forms a compound with a metal included in the outer electrodes 40 or a metal included in the conductive fillers included in the outer electrodes 40.

The total number obtained by summing the number of the first inner electrode layers 31 and the number of the second inner electrode layers 32 may be 2 or more and 100 or less, for example.

The thickness of the first inner electrode layer 31 and the thickness of the second inner electrode layer 32 are preferably, for example, about 0.5 μm or more and about 3 μm or less.

Divided regions of the multilayer body 2 in the lamination direction T will be described. As illustrated in FIGS. 2 and 4, the multilayer body 2 can be divided into an inner layer portion 10 and outer layer portions 11 in the lamination direction T. The outer layer portions 11 include a first outer layer portion 12 and a second outer layer portion 13.

The portion of the multilayer body 2 located between the position of the inner electrode layer closest to the first main surface 3 and the position of the inner electrode layer closest to the second main surface 4 in the lamination direction T is defined as the inner layer portion 10.

Specifically, the inner layer portion 10 is referred to the portion in which the first and second inner electrode layers 31 and 32 and the dielectric layers 20 are alternately laminated, which is the portion from the first inner electrode layer 31 or the second inner electrode layer 32 closest to the first main surface 3 to the first inner electrode layer 31 or the second inner electrode layer 32 closest to the second main surface 4.

The portion of the multilayer body 2 located between the first main surface 3 and the position of the inner electrode layer closest to the first main surface 3 in the lamination direction T is defined as the first outer layer portion 12. The first outer layer portion 12 is the portion of the multilayer body 2 located between the inner layer portion 10 and the first main surface 3.

The portion of the multilayer body 2 located between the second main surface 4 and the position of the inner electrode layer closest to the second main surface 4 in the lamination direction T is defined as the second outer layer portion 13. The second outer layer portion 13 is the portion of the multilayer body 2 located between the inner layer portion 10 and the second main surface 4.

In other words, the outer layer portions 11 are located on both sides of the inner layer portion 10 in the lamination direction T. The dielectric layers 20 included in the outer layer portions 11 preferably contain, in particular, BaTiO₃ or CaZrO₃ as the main material and preferably include Si, V, Mn, Mg, Ni, or the like as an additive.

Divided regions of the multilayer body 2 in the width direction W will be described. As illustrated in FIGS. 3 and 4, the multilayer body 2 can be divided into a core portion 25 and side-surface-side gaps 14 in the width direction W. The side-surface-side gaps 14 include a first side-surface-side gap 15 and a second side-surface-side gap 16.

In the width direction W, the portion of the multilayer body 2 in which the inner electrode layers 30 are located is defined as the core portion 25.

The portion of the multilayer body 2 located between the core portion 25 and the first side surface 5 in the width direction W is defined as the first side-surface-side gap 15. The portion of the multilayer body 2 located between the core portion 25 and the second side surface 6 in the width direction W is defined as the second side-surface-side gap 16. The side-surface-side gaps 14 do not include the inner electrode layers. The side-surface-side gaps 14 only include the dielectric layers 20. The side-surface-side gaps are also referred to as the W gaps or the side gaps.

Divided regions of the core portion 25 in the lamination direction T will be described. As illustrated in FIG. 4, the core portion 25 can be divided into an effective layer portion 26 and ineffective portions 27 in the lamination direction T. The ineffective portions 27 include a first ineffective portion 28 and a second ineffective portion 29.

In the lamination direction T, the portion of the core portion 25 in which the first inner electrode layers 31 or the second inner electrode layers 32 are located is defined as the effective layer portion 26.

The portion of the core portion 25 located between the effective layer portion 26 and the first main surface 3 in the lamination direction T is defined as the first ineffective portion 28. The portion of the core portion 25 located between the effective layer portion 26 and the second main surface 4 in the lamination direction T is defined as the second ineffective portion 29. The ineffective portions 27 do not include the inner electrode layers 30. The ineffective portions 27 only include dielectric layers 20.

The portion in which the first inner electrode layers 31 and the second inner electrode layers 32 overlap one another is defined as a facing electrode portion 38. In the facing electrode portion 38, the first facing portions 33 and the second facing portions 34 overlap one another. In the multilayer ceramic capacitor 1, the facing portions of the inner electrode layers 30 face one another with the dielectric layers 20 interposed therebetween, and this generates capacitance. In other words, capacitance is generated in the facing electrode portion 38. This capacitance provides the characteristics of a capacitor in the multilayer ceramic capacitor 1.

End-surface-side gaps 17 will be described with reference to FIGS. 2 and 3. The portions of the multilayer body 2 located between the facing electrode portion 38 and the end surfaces and including the extended portions of either the first inner electrode layers 31 or the second inner electrode layers 32 are defined as the end-surface-side gaps 17. The end-surface-side gaps 17 are also referred to as the L gaps.

The end-surface-side gaps 17 include a first end-surface-side gap 18 and a second end-surface-side gap 19. The portion located between the facing electrode portion 38 and the first end surface 7 and including the first extended portions 35 is defined as the first end-surface-side gap 18. Similarly, the portion located between the facing electrode portion 38 and the second end surface 8 and including the second extended portions 36 is defined as the second end-surface-side gap 19.

The outer electrodes 40 include the first outer electrode 41 and the second outer electrode 42. The outer electrode 40 located on the first end surface 7 and coupled to the first inner electrode layers 31 is defined as the first outer electrode 41. The first outer electrode 41 may be formed not only on the first end surface 7 but also on a portion of the first main surface 3, a portion of the second main surface 4, a portion of the first side surface 5, and a portion of the second side surface 6. In the present example embodiment, the first outer electrode 41 extends from the first end surface 7 over a portion of the first main surface 3, a portion of the second main surface 4, a portion of the first side surface 5, and a portion of the second side surface 6.

The outer electrode 40 located on the second end surface 8 and coupled to the second inner electrode layers 32 is defined as the second outer electrode 42. The second outer electrode 42 may be provided not only on the second end surface 8 but also on a portion of the first main surface 3, a portion of the second main surface 4, a portion of the first side surface 5, and a portion of the second side surface 6. In the present example embodiment, the second outer electrode 42 extends from the second end surface 8 over a portion of the first main surface 3, a portion of the second main surface 4, a portion of the first side surface 5, and a portion of the second side surface 6.

Each outer electrode 40 includes an underlying electrode layer 50 and a plating layer 60. The underlying electrode layer 50 included in the first outer electrode 41 is defined as the first underlying electrode layer 51. The underlying electrode layer 50 included in the second outer electrode 42 is defined as the second underlying electrode layer 52.

The plating layer 60 included in the first outer electrode 41 is defined as the first plating layer 61. The plating layer 60 included in the second outer electrode 42 is defined as the second plating layer 62.

The underlying electrode layers 50 may be fired layers or conductive resin layers. The following description is on the assumption that the underlying electrode layers 50 are fired layers. The fired layers include a glass component and a metal. The glass component includes at least one element selected from, for example, B, Si, Ba, Mg, Al, Li, and the like. The metal component includes at least one metal selected from, for example, Cu, Ni, Ag, Pd, an Ag—Pd alloy, Au, and the like.

Each fired layer may include a plurality of layers. These fired layers are formed by applying a conductive paste including a glass component and a metal onto the multilayer body 2 and firing it. The firing can be performed simultaneously with firing of the inner electrode layers 30 and the dielectric layers 20 or after the firing of these layers. In the case in which the fired layers are formed simultaneously with the firing of the inner electrode layers and the dielectric layers, it is preferable that the fired layers be formed so as to include a dielectric material instead of a glass component.

The thickness in the longitudinal direction L of the fired layers located on the first end surface 7 and the second end surface 8, measured at the lamination-direction center 111, is preferably, for example, about 3 μm or more and about 160 μm or less.

For example, in the case in which the fired layers as the underlying electrode layers 50 are formed on a portion of the first main surface 3, a portion of the second main surface 4, a portion of the first side surface 5, and a portion of the second side surface 6, the thickness in the lamination direction T of the underlying electrode layers 50 located on the first main surface 3, the second main surface 4, the first side surface 5, and the second side surface 6, measured at the center positions in the longitudinal direction L, is preferably about 3 μm or more and about 40 μm or less, for example.

The first plating layer 61 is located so as to cover the first underlying electrode layer 51. The second plating layer 62 is located so as to cover the second underlying electrode layer 52.

The material of the plating layers 60 includes, for example, at least one metal selected from Cu, Ni, Sn, Ag, Pd, an Ag—Pd alloy, or Au, and the like.

The plating layer 60 may include a plurality of layers. In the present example embodiment, each of the first plating layer 61 and the second plating layer 62 includes two plating layers. In the case in which each plating layer 60 includes two layers, it is preferable that one layer is a nickel plating layer, and that the other layer is a tin plating layer.

The nickel plating layer included in the first plating layer 61 is defined as the first nickel plating layer 63. The tin plating layer included in the first plating layer 61 is defined as the first tin plating layer 65. Similarly, the nickel plating layer included in the second plating layer 62 is defined as the second nickel plating layer 64. The tin plating layer included in the second plating layer 62 is defined as the second tin plating layer 66.

The nickel plating layers reduce or prevent erosion of the underlying electrode layers 50 by solder when the multilayer ceramic capacitor 1 is mounted.

The tin plating layers improve the wettability of solder when the multilayer ceramic capacitor 1 is mounted. This makes the mounting easy.

Hence, it is preferable that the nickel plating layers and the tin plating layers be formed in this order from the plating layers 60 in contact with the underlying electrode layers 50. Each plating layer 60 may include three or more layers. The main component of the plating layers 60 may be a metal component other than Ni and Sn.

The preferable thickness of one layer in the plating layer 60 is about 1 μm or more and about 15 μm or less, for example.

Each underlying electrode layer 50 may include a fired layer and a conductive resin layer. In this case, each underlying electrode layer 50 has a two-layer structure including the fired layer and the conductive resin layer laminated in this order. For example, the conductive resin layers are located so as to cover the underlying electrode layers 50.

Specifically, the conductive resin layers are located on the underlying electrode layers 50 located on the first end surface 7 and the second end surface 8. The conductive resin layers are preferably located so as to extend over the underlying electrode layers 50 located on the first main surface 3, the second main surface 4, the first side surface 5, and the second side surface 6. However, the conductive resin layers may be located only on the underlying electrode layers 50 located on the first end surface 7 and the second end surface 8.

Since the conductive resin layers include a resin and a metal, they are more flexible than the fired layers. The conductive resin layers function as buffer layers. Hence, when bending stress is exerted on the mounting substrate, and even when this stress causes physical force to act on the multilayer ceramic capacitor 1, cracks are less likely to occur in the multilayer ceramic capacitor 1.

In addition, even when force due to thermal cycles acts on the multilayer ceramic capacitor 1, cracks are less likely to occur in the multilayer ceramic capacitor 1.

The resin included in the conductive resin layers may be a thermosetting resin such as an epoxy resin, a phenol resin, a urethane resin, a silicone resin, or a polyimide resin. Among these, an epoxy resin is one of suitable resins because it is excellent in heat resistance, moisture resistance, and adhesion. The conductive resin layers may be formed of two or more kinds of resin such as a combination of an epoxy resin and a phenol resin, and the like.

The conductive resin layers preferably include not only a resin but also a curing agent. In the case in which an epoxy resin is used as the resin, it is preferable that the curing agent be a compound such as a phenol-based, amine-based, acid anhydride-based, imidazole-based, active ester-based, or amide-imide-based compound.

The conductive resin layers include metal. Since the conductive resin layers include metal, they are electrically conductive. The metal included in the conductive resin layers are included as metal powder, in other words, conductive fillers. The conductive fillers have, for example, flat shapes. Contacts between conductive fillers and conductive fillers form electrical conduction paths inside the conductive resin layers. The electrical conduction paths thus formed make the conductive resin layers electrically conductive.

The metal included in the conductive resin layers may be Ag, Cu, Ni, Sn, Bi, an alloy including one of these, or the like. It is, in particular, preferable that the metal include Ag. The Ag may be in the form of pure Ag. Alternatively, the Ag may be in the form of an alloy including Ag. For example, the metal may be at least one metal selected from Ag, Ag-coated Cu, Ag-coated Ni, and Ag-coated alloy powder.

In the case in which a material composed of metal powder with the surface coated with Ag is used, the metal powder to be used is preferably copper powder or nickel powder. Antioxidant treated Cu may also be used. The reason why a metal coated with Ag is used is that a low-cost metal can be used as the base material while the characteristics of Ag are kept.

The metal content of the conductive resin layers is preferably about 35 vol % or more and about 75 vol % or less of the volume of the entire conductive resin layers, for example. The shapes of the conductive fillers are not limited to flat shapes mentioned above and may be spherical shapes or the like. Spherical metal powder and flat metal powder may be mixed and used. The average particle diameter of the conductive fillers is also not particularly limited and may be, for example, about 0.3 μm or more and about 10 μm or less. The thickness of the conductive resin layers is preferably about 10 μm or more and about 200 μm or less.

Note that the underlying electrode layers 50 may include only the conductive resin layers without the fired layers. In other words, the conductive resin layers may be formed directly on the multilayer body 2 without forming the fired layers.

The size of the multilayer ceramic capacitor 1 including the multilayer body 2 and the outer electrodes will be described. The dimension of the multilayer ceramic capacitor 1 in the longitudinal direction L may be, for example, about 1.0 mm or more and about 4.0 mm or less. The dimension of the multilayer ceramic capacitor 1 in the width direction W may be, for example, about 1.0 mm or more and about 3.0 mm or less. The dimension of the multilayer ceramic capacitor 1 in the lamination direction T may be, for example, about 1.0 mm or more and about 3.0 mm or less. Note that the dimensions of the multilayer ceramic capacitor 1 are not limited to these examples.

The dimension of the multilayer ceramic capacitor 1 in the longitudinal direction L may be larger than the dimension of the multilayer ceramic capacitor 1 in the width direction W and the dimension of the multilayer ceramic capacitor 1 in the lamination direction T.

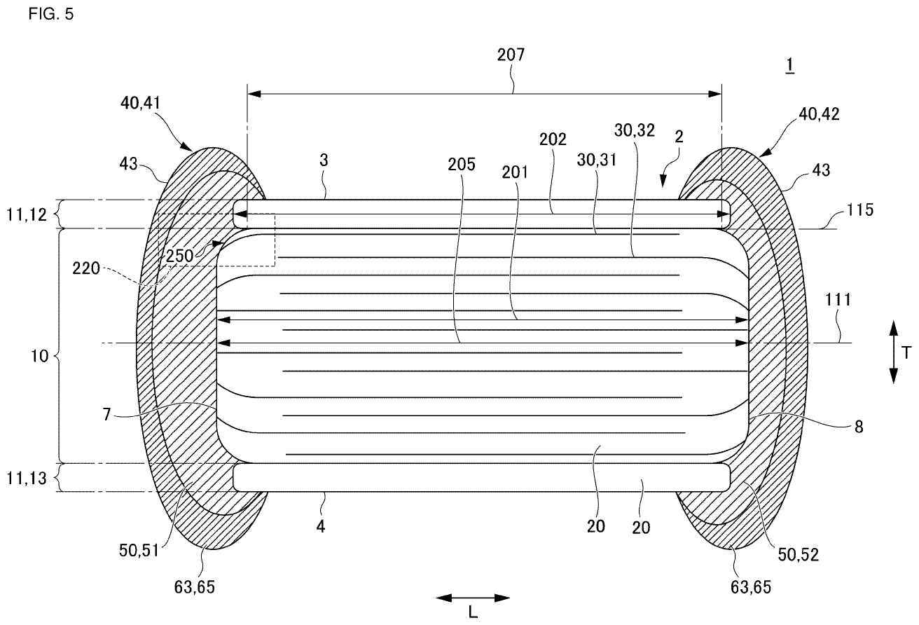

The dimensions of the inner layer portion 10 and the outer layer portions 11 in the multilayer ceramic capacitor 1 of the present example embodiment will be described with reference to FIG. 5. FIG. 5 is a diagram corresponding to the cross-sectional view taken along line 101-101 in FIG. 1. In FIG. 5, to show the features of the present example embodiment, characteristic portions are exaggerated.

In the cross section, parallel to the longitudinal direction L and the lamination direction T, at the width-direction center 113 in the multilayer ceramic capacitor 1 of the present example embodiment, the dimension of the inner layer portion 10 in the longitudinal direction L is larger than the dimension of the outer layer portions 11 in the longitudinal direction L.

In this description, the dimension of the inner layer portion 10 in the longitudinal direction L is the average value of the entire inner layer portion 10. The cross section, parallel to the longitudinal direction L and the lamination direction T, at the width-direction center 113 is defined as the LT cross section. The dimension of the inner layer portion 10 in the longitudinal direction L in the LT cross section is defined as the inner-layer-portion dimension 201. The value obtained by averaging the inner-layer-portion dimensions 201 measured in the entire region of the inner layer portion 10 in the lamination direction T is defined as the inner-layer-portion average dimension.

Similarly, in this description, the dimension of each of the outer layer portions 11 in the longitudinal direction L is the average value of the entire outer layer portion 11. The dimension of the outer layer portion 11 in the longitudinal direction L in the LT cross section is defined as the outer-layer-portion dimension 202. The value obtained by averaging the outer-layer-portion dimensions 202 measured in the entire region of the outer layer portion 11 in the lamination direction T is defined as the outer-layer-portion average dimension.

In the multilayer ceramic capacitor 1 of the present example embodiment, the inner-layer-portion average dimension is larger than the outer-layer-portion average dimension.

This means that the inner-layer-portion average dimension>the outer-layer-portion average dimension.

Since the inner-layer-portion average dimension is larger than the outer-layer-portion average dimension in the multilayer ceramic capacitor 1 of the present example embodiment, the contact between the inner electrode layers 30 and the outer electrodes 40 is favorable. Hence, after the multilayer ceramic capacitor 1 is mounted on a wiring board or the like, the failure rate of the multilayer ceramic capacitor 1 when it discharges electricity is reduced.

Since the inner-layer-portion average dimension is larger than the outer-layer-portion average dimension, the distance between the inner electrode layers 30 and the outer electrodes 40 can be reduced. This makes the contact between the inner electrode layers 30 and the outer electrodes 40 favorable and thus reduces the failure rate of the multilayer ceramic capacitor 1 when it discharges electricity after being mounted.

The inner-layer-portion average dimension is larger than the outer-layer-portion average dimension in the multilayer ceramic capacitor 1 of the present example embodiment. This causes steps in the dielectric layers 20 near the boundaries between the outer layer portions 11 and the inner layer portion 10 at the end surfaces in the LT cross section. In other words, steps are present near the boundaries between the outer layer portions 11 and the inner layer portion 10 at the end surfaces.

In the LT cross section of the multilayer ceramic capacitor 1 of the present example embodiment, the dimension of the inner layer portion 10 in the longitudinal direction L at the lamination-direction center 111 is larger than the dimension of the inner layer portion 10 in the longitudinal direction L at each end portion in the lamination direction T.

As illustrated in FIG. 5, the dimension of the inner layer portion 10 at the lamination-direction center 111 in the LT cross section is defined as the inner-layer-portion center dimension 205.

As illustrated in FIG. 5, an end portion of the inner layer portion 10 in the lamination direction T is defined as a lamination-direction inner-layer end portion 115. The dimension of the inner layer portion 10 in the longitudinal direction L at the lamination-direction inner-layer end portion 115 in the LT cross section is defined as the inner-layer-portion end-portion dimension 207.

In the multilayer ceramic capacitor 1 of the present example embodiment, the inner-layer-portion center dimension 205 is larger than the inner-layer-portion end-portion dimension 207.

This means that the inner-layer-portion center dimension>the inner-layer-portion end-portion dimension.

As illustrated in FIG. 5, the surfaces of the outer electrodes 40 on the outer sides are defined as the outer-electrode surfaces 43. Since the inner-layer-portion center dimension 205 is larger than the inner-layer-portion end-portion dimension 207 in the multilayer ceramic capacitor 1 of the present example embodiment, the distance from the inner layer portion 10 to each outer-electrode surface 43 at each lamination-direction inner-layer end portion 115 can be relatively large.

This increases the moisture ingress path at each corner portion 250 of the inner layer portion 10 where the moisture resistance tends to be degraded by moisture ingress. Thus, in the multilayer ceramic capacitor 1 of the present example embodiment, the failure rate is low, and the moisture resistance can be ensured.

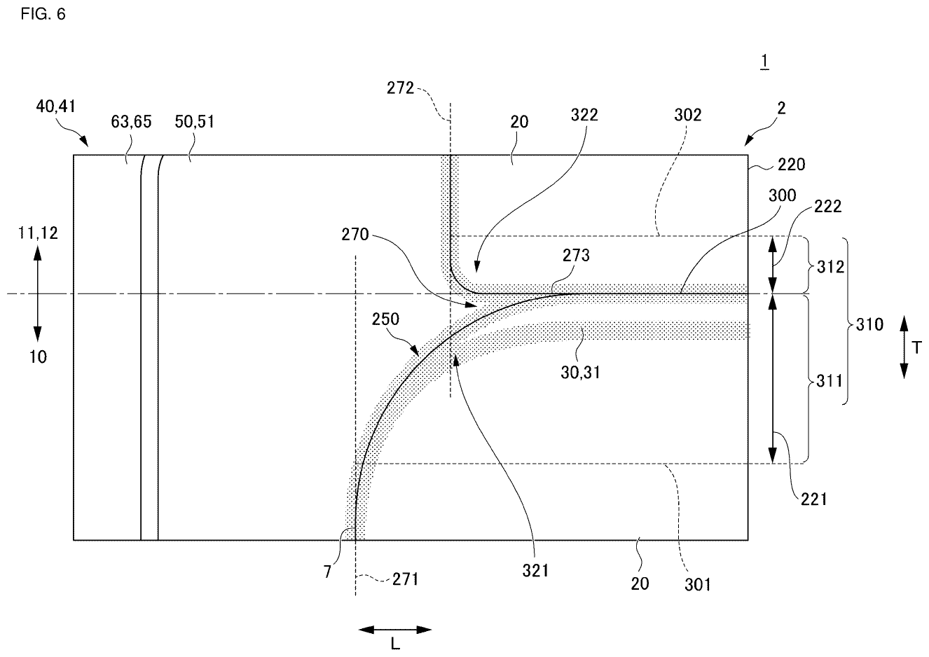

Recesses 270 formed by the outer layer portions 11 and the inner layer portion 10 will be described with reference to FIG. 6. FIG. 6 is an enlarged view of the framed area 220 in FIG. 5. The multilayer ceramic capacitor 1 of the present example embodiment, in the LT cross section, includes recesses 270 at or adjacent to the boundaries between the outer layer portions 11 and the inner layer portion 10 at the first end surface 7 or the second end surface 8, the recesses 270 being recessed from both of the inner layer portion 10 and the outer layer portions 11.

At the first end surface 7, the end portion of the inner layer portion 10 on the first end surface 7 side is defined as the inner-layer-portion end 271. Similarly, at the first end surface 7, the end portion of the outer layer portion 11 on the first end surface 7 side is defined as the outer-layer-portion end 272. The bottom portion of the recess 270 is defined as the recess bottom portion 273.

As illustrated in FIG. 6, the recess bottom portion 273 is located farther from the first end surface 7 than both of the inner-layer-portion end 271 and the outer-layer-portion end 272 in the longitudinal direction. In other words, the recess 270 has a shape recessed from the inner layer portion 10 and the outer layer portion 11.

The boundary between the outer layer portion 11 and the inner layer portion 10 is defined as the inner-outer layer boundary 300. In the multilayer ceramic capacitor 1 of the present example embodiment, not only is the inner-layer-portion center dimension 205 larger than the inner-layer-portion end-portion dimension 207 as described above, but also the portion of the inner-outer layer boundary 300 exposed on the end surface includes the recess 270 recessed from the inner layer portion 10 and the outer layer portion 11 other than the inner-outer layer boundary 300.

As described above, in the multilayer ceramic capacitor 1 of the present example embodiment, not only does the relationship that the inner-layer-portion center dimension 205>the inner-layer-portion end-portion dimension 207 is satisfied, but also the multilayer ceramic capacitor 1 includes the recesses 270. Hence, the distance from the inner layer portion 10 at the lamination-direction inner-layer end portion 115 to the outer-electrode surface 43 can be relatively long. This further increases the moisture ingress path at each corner portion 250 of the inner layer portion 10. This further reduces the failure rate of the multilayer ceramic capacitor 1 of the present example embodiment and ensures its moisture resistance.

A boundary peripheral region 310 will be described with reference to FIG. 6. A region around the inner-outer layer boundary 300, which is the boundary between the inner layer portion 10 and the outer layer portion 11, is defined as a boundary peripheral region 310. The boundary peripheral region 310 includes an outer-layer boundary peripheral region 312 and an inner-layer boundary peripheral region 311.

In the LT cross section, the region within about 15 μm from the inner-outer layer boundary 300 in the lamination direction T toward the lamination-direction center 111 is defined as the inner-layer boundary peripheral region 311. The dimension 221 in FIG. 6 is about 15 μm, for example. The boundary of the inner-layer boundary peripheral region 311 opposed to the inner-outer layer boundary 300 is defined as the inner-layer peripheral boundary 301. Note that the lamination-direction center 111 is not indicated in in FIG. 6 but is indicated in FIG. 5 and other figures.

As illustrated in FIG. 6, the inner-layer boundary peripheral region 311 extends from the inner-outer layer boundary 300 in the lamination direction T toward the lamination-direction center 111. The inner-layer boundary peripheral region 311 is not limited to the region from one end portion of the inner-layer boundary peripheral region 311 in the longitudinal direction L to the other end portion in the longitudinal direction L but is a region extending in the width direction W in the inner layer portion 10.

In the LT cross section, the region within about 5 μm from the inner-outer layer boundary 300 in the lamination direction T toward the main surface is defined as the outer-layer boundary peripheral region 312. The dimension 222 in FIG. 6 is about 5 μm, for example. The boundary of the outer-layer boundary peripheral region 312 opposed to the inner-outer layer boundary 300 is defined as the outer-layer peripheral boundary 302.

As illustrated in FIG. 6, the outer-layer boundary peripheral region 312 extends from the inner-outer layer boundary 300 in the lamination direction T toward the main surface. The outer-layer boundary peripheral region 312 is not limited to the region from one end portion of the outer-layer boundary peripheral region 312 in the longitudinal direction L to the other end portion in the longitudinal direction L but is a region extending in the width direction W in the outer layer portion 11.

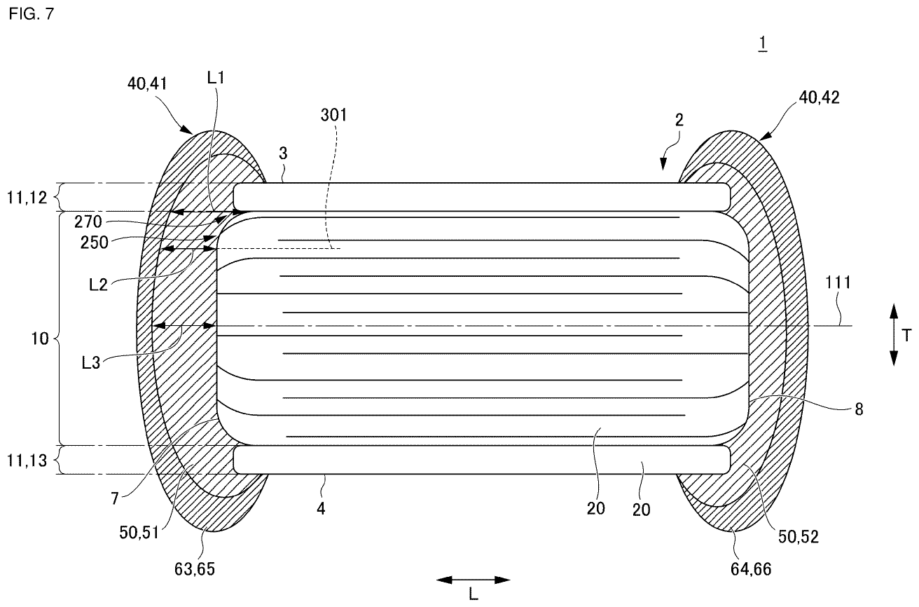

The thickness of the underlying electrode layers 50 of the multilayer ceramic capacitor 1 of the present example embodiment will be described with reference to FIG. 7. FIG. 7 is a diagram corresponding to the cross-sectional view taken along line 101-101 in FIG. 1.

In the multilayer ceramic capacitor 1 of the present example embodiment, the relationship L2<L1<L3 is satisfied, where L1 is the thickness of the underlying electrode layer 50 at the recess 270, L2 is the thickness of the underlying electrode layer 50 at the end portion of the boundary peripheral region 310 on the lamination-direction center 111 side of the inner layer portion 10, in other words, the thickness of the underlying electrode layer 50 at the inner-layer peripheral boundary 301, and L3 is the thickness of the underlying electrode layer 50 at the lamination-direction center 111.

As described above, the multilayer ceramic capacitor 1 of the present example embodiment includes the recesses 270. As illustrated in FIGS. 6 and 7, the underlying electrode layers 50 are located in the recesses 270 so as to reach the recess bottom portions 273. Then, the thickness of the underlying electrode layer 50 is such that L2 at the inner-layer peripheral boundary 301<L1 at the recess 270<L3 at the lamination-direction center 111.

As mentioned above, in the multilayer ceramic capacitor 1 of the present example embodiment, the underlying electrode layer 50 is thicker at the corner portion 250 of the inner layer portion 10 than at the inner-layer peripheral boundary 301. Hence, moisture is less likely to enter the corner portion 250 of the inner layer portion 10, which has been prone to moisture entry, and this improves the reliability in moisture resistance.

The ratio of the thickness L1 of the underlying electrode layer 50 at the recess 270 to the thickness L3 of the underlying electrode layer 50 at the lamination-direction center 111 is preferably about 75% or more and about 95% or less, for example.

Since the thickness ratio of the underlying electrode layer 50, specifically, “the ratio of L1 at the recess 270 to L3 at the lamination-direction center 111” is in a range from about 75% to about 95%, both inclusive, for example, the moisture resistance reliability is kept the most favorable, and a separation between the inner layer portion 10 and the outer layer portion 11 is less likely to occur.

If the thickness ratio of the underlying electrode layer 50 is less than about 75%, it is possible that the moisture ingress path is not long enough, and the moisture resistance reliability is not high enough in some cases.

If the thickness ratio of the underlying electrode layer 50 is more than about 95%, the difference in stress between the inner layer portion 10 and the outer layer portion 11 becomes large when the multilayer ceramic capacitor 1 is fired, a separation between the inner layer portion 10 and the outer layer portion 11 is more likely to occur.

The difference in stress between the inner layer portion 10 and the outer layer portion 11 when the multilayer ceramic capacitor 1 is fired as mentioned above remains near the interface between the inner layer portion 10 and the outer layer portion 11 as residual stress after firing. The type of residual stress may be tensile stress, compressive stress, or the like, depending on the shrinkage patterns of the inner layer portion 10 and the outer layer portion 11. The presence or absence and the magnitude of residual stress can be determined by Raman spectroscopy and X-ray diffraction.

The residual stress is low in the multilayer ceramic capacitor 1 of the present example embodiment. Hence, the occurrence of a separation and cracks due to temperature changes or the like can be reduced or prevented, and the multilayer ceramic capacitor 1 having higher moisture resistance reliability and a lower failure rate can be achieved.

Curvatures of the boundary peripheral region in the multilayer ceramic capacitor 1 of the present example embodiment will be described with reference to FIG. 6.

In the LT cross section of the multilayer ceramic capacitor 1 of the present example embodiment, the radius of curvature of the outer layer portion 11 in the boundary peripheral region 310, exposed on the first end surface 7 or the second end surface 8, is smaller than the radius of curvature of the inner layer portion 10 in the boundary peripheral region 310, exposed on the first end surface 7 or the second end surface 8.

The radius of curvature of the outer layer portion 11 in the boundary peripheral region 310 is indicated by arrow 322 in FIG. 6. This radius of curvature is defined as the outer-layer-portion radius of curvature 322. The radius of curvature of the inner layer portion 10 in the boundary peripheral region 310 is indicated by arrow 321 in FIG. 6. This radius of curvature is defined as the inner-layer-portion radius of curvature 321.

In the multilayer ceramic capacitor 1 of the present example embodiment, the relationship that the radius of curvature of the outer layer portion in the boundary peripheral region<the radius of curvature of the inner layer portion in the boundary peripheral region is satisfied. In other words, the relationship that the outer-layer-portion radius of curvature 322<the inner-layer-portion radius of curvature 321 is satisfied.

Since the outer-layer-portion radius of curvature 322 is smaller than the inner-layer-portion radius of curvature 321, the portions of the inner electrode layers 30 exposed on the end surface, near the corner portion 250 of the inner layer portion 10, are farther from the outer-electrode surface 43. This increases the moisture ingress path and further improves the moisture resistance.

In the LT cross section of the multilayer ceramic capacitor 1 of the present example embodiment, the radius of curvature of the inner layer portion 10 in the boundary peripheral region 310, exposed on the first end surface 7 or the second end surface 8, is about 10 μm or more and about 20 μm or less, for example.

Since the inner-layer-portion radius of curvature 321 is about 10 μm or more and about 20 μm or less, for example, the moisture resistance can be kept favorable, and the effects on the electrical characteristics can be reduced or minimized. If the inner-layer-portion radius of curvature 321 is less than 10 μm, the distance between the outer-electrode surface 43 and the inner electrode layers 30 at the corner portion 250 of the inner layer portion 10 is shorter. It would sometimes make it difficult to ensure the moisture resistance reliability. If the inner-layer-portion radius of curvature 321 exceeds about 20 μm, the extended portions of the inner electrode layers 30 would be sometimes excessively curved. This would sometimes make it difficult to keep the electrical characteristics of the multilayer ceramic capacitor.

The outer-layer-portion radius of curvature 322 is preferably about 3 μm or more and about 6 μm or less, for example.

The effect of improving the moisture resistance in the multilayer ceramic capacitor 1 of the present example embodiment described above is more significant in the case in which the dimensions of the multilayer ceramic capacitor 1 are within the following ranges. Specifically, the effect of improving the moisture resistance is more significant in the case in which the dimensions of the multilayer ceramic capacitor 1 including the outer electrodes 40 are such that the dimension in the longitudinal direction L is about 1.0 mm or more and about 4.0 mm or less, the dimension in the lamination direction T is about 1.0 mm or more and about 3.0 mm or less, and the dimension in the width direction W is about 1.0 mm or more and about 3.0 mm or less, for example.

The effect of improving the moisture resistance is even more significant in the case in which the dimension in the longitudinal direction L is about 3.5 mm or more.

A method of measuring the dimensions, the radii of curvature, and the like mentioned above will be described. A surface parallel to the longitudinal direction L and the lamination direction T is polished at the width-direction center 113 of the multilayer ceramic capacitor 1. This exposes the LT cross section. The exposed LT cross section is observed, so that the dimensions, the radii of curvature, and the like can be measured.

A non-limiting example of a method of manufacturing the multilayer ceramic capacitor 1 will be described. Note that the method of manufacturing the multilayer ceramic capacitor 1 is not limited to the method described below.

Dielectric sheets and a conductive paste for the inner electrode layers are prepared. The dielectric sheets and the conductive paste for the inner electrode layers include a binder and a solvent. The binder and the solvent may be publicly-known ones. Note that the dielectric sheets are also referred to as ceramic green sheets.

Dielectric sheets having inner electrode layer patterns are prepared. Specifically, the conductive paste for the inner electrode layers is applied onto the dielectric sheets in specified patterns, so that dielectric sheets each having a pattern of a first inner electrode layer and dielectric sheets each having a pattern of a second inner electrode layer are prepared. The printing is performed by, for example, screen printing, gravure printing, or the like.

A specified number of dielectric sheets on which no inner electrode layer pattern is printed are laminated to form a portion to serve as the first outer layer portion. On this portion, a dielectric sheet on which the first inner electrode layer pattern is printed and a dielectric sheet on which the second inner electrode layer pattern is printed are alternately laminated to form a portion to serve as the inner layer portion. Further on the portion to serve as the inner layer portion, a specified number of dielectric sheets on which no inner electrode layer pattern is printed are laminated to form a portion to serve as the second outer layer portion. With these processes, a multilayer sheet is formed.

The dielectric paste for the dielectric sheets that serve as the outer layer portions is defined as the outer-layer paste. The dielectric paste for the dielectric sheets that serve as the inner layer portion is defined as the inner-layer paste. When the outer-layer paste is prepared, a larger amount of organic component is added so that shrinkage is more likely to occur during firing. The outer-layer paste is preferably prepared so that the outer-layer paste shrinks more than the inner-layer paste during firing.

Specifically, the ratio of the volume of the organic matter to the sum of the volumes of the dielectric material and the organic matter in the outer-layer paste is set higher than in the inner-layer paste. Alternatively, the degree of shrinkage of the outer-layer paste may be controlled by the kind and the amount of an additive.

The formed multilayer sheet is pressed in the lamination direction by using an isostatic press or the like to form a multilayer block.

The multilayer block is cut into individual multilayer chips. Specifically, the multilayer block is cut by using a cutting blade into individual pieces to produce green multilayer bodies.

The multilayer chips are fired to produce multilayer bodies. Before firing, the vertex portions and the ridge line portions of the multilayer chips may be rounded by barrel polishing or the like. The firing temperature is dependent on the material of the dielectric and the inner electrode layers but is preferably about 900° C. or more and about 1400° C. or less, for example. Barrel polishing or the like can be performed on the multilayer bodies after firing.

Next, the outer electrodes are formed. First, a conductive paste to serve as the underlying electrode layers is applied on both end surfaces of the multilayer body 2 to form the underlying electrode layers. In the process of forming the fired layers as the underlying electrode layers, a conductive paste including a glass component and a metal is applied by dipping or the like, and then a firing process is performed. In this process, the firing temperature is preferably about 700° C. or more and about 900° C. or less, for example.

After that, the plating layers are formed on the surfaces of the underlying electrode layers. Nickel plating layers and tin plating layers are formed in this order on the underlying electrode layers. These plating layers are formed by, for example, barrel plating. Through these processes, multilayer ceramic capacitors are obtained.

Example embodiments of the present invention have been described as above. However, the present invention is not limited to the above-described example embodiments, and various kinds of changes, variations, and combinations are possible. The multilayer ceramic capacitors described above are examples of multilayer ceramic electronic components. The techniques, example embodiments, and modifications thereto described above can be applied to multilayer ceramic electronic components other than multilayer ceramic capacitors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including dielectric layers and inner electrode layers laminated in a lamination direction and outer layer portions located on both sides of the inner layer portion in the lamination direction;
the multilayer body including first and second main surfaces opposed to each other in the lamination direction, first and second side surfaces opposed to each other in a width direction orthogonal to the lamination direction, and first and second end surfaces opposed to each other in a longitudinal direction orthogonal to the lamination direction and the width direction; and
outer electrodes located on the first and second end surfaces and coupled to the inner electrode layers; wherein
the multilayer ceramic capacitor includes a recess at or adjacent to boundaries between the outer layer portion and the inner layer portion on the first or second end surface, the recess being recessed from the inner layer portion and the outer layer portion.

2. The multilayer ceramic capacitor according to claim 1, wherein
each of the outer electrodes includes an underlying electrode located on the first or second end surface and a plating layer located on the underlying electrode; and
when a region around a boundary between the inner layer portion and the outer layer portion is defined as a boundary peripheral region, a relationship L2<L1<L3 is satisfied; wherein
L1 is a thickness of the underlying electrode at the recess;
L2 is a thickness of the underlying electrode at an end portion of the boundary peripheral region on a center side in the lamination direction of the inner layer portion; and
L3 is a thickness of the underlying electrode at the center in the lamination direction.

3. The multilayer ceramic capacitor according to claim 2, wherein a ratio of the thickness L1 of the underlying electrode at the recess to the thickness L3 of the underlying electrode at the center in the lamination direction is about 75% or more and about 95% or less.

4. The multilayer ceramic capacitor according to claim 1, wherein when a region around a boundary between the inner layer portion and the outer layer portion is defined as a boundary peripheral region, in a cross section parallel to the longitudinal direction and the lamination direction at the center in the width direction, a radius of curvature of the outer layer portion in the boundary peripheral region, exposed on the first or second end surface, is smaller than a corresponding radius of curvature of the inner layer portion in the boundary peripheral region, exposed on the first or second end surface.

5. The multilayer ceramic capacitor according to claim 4, wherein in the cross section parallel to the longitudinal direction and the lamination direction at the center in the width direction, the radius of curvature of the inner layer portion in each boundary peripheral region, exposed on the first or second end surface, is about 10 μm or more and about 20 μm or less.

6. The multilayer ceramic capacitor according to claim 1, wherein in a cross section parallel to the longitudinal direction and the lamination direction at a center in the width direction, a dimension of the inner layer portion in the longitudinal direction is larger than a dimension of each of the outer layer portions in the longitudinal direction.

7. The multilayer ceramic capacitor according to claim 1, wherein in a cross section parallel to the longitudinal direction and the lamination direction at a center in the width direction, an inner-layer-portion average dimension is larger than an outer-layer-portion average dimension.

8. The multilayer ceramic capacitor according to claim 1, wherein in a cross section parallel to the longitudinal direction and the lamination direction at the center in the width direction, a dimension of the inner layer portion in the longitudinal direction at a center in the lamination direction is larger than a dimension of the inner layer portion in the longitudinal direction at each end portion in the lamination direction.

9. The multilayer ceramic capacitor according to claim 1, wherein the recess includes a recess bottom portion located farther from the first end surface than both of an inner-layer portion end and an outer-layer portion end in the longitudinal direction.

10. The multilayer ceramic capacitor according to claim 4, wherein the boundary peripheral region includes an outer-layer boundary peripheral region and an inner-layer boundary peripheral region.

11. The multilayer ceramic capacitor according to claim 10, wherein a dimension of the inner-layer boundary peripheral region is about 15 μm.

12. The multilayer ceramic capacitor according to claim 10, wherein a dimension of the outer-layer boundary peripheral region is about 5 μm.

13. The multilayer ceramic capacitor according to claim 9, wherein
each of the outer electrodes includes an underlying electrode layer located on the first or second end surface and a plating layer located on the underlying electrode layer; and
the underlying electrode layers are located in the recess so as to reach the recess bottom portion.

14. The multilayer ceramic capacitor according to claim 1, wherein
each of the outer electrodes includes an underlying electrode layer located on the first or second end surface and a plating layer located on the underlying electrode layer; and
the underlying electrode layer is thicker at a corner portion of the inner layer portion than at an inner-layer peripheral boundary.

15. The multilayer ceramic capacitor according to claim 4, wherein in the cross section parallel to the longitudinal direction and the lamination direction at the center in the width direction, the radius of curvature of each of the outer layer portions in the boundary peripheral region, exposed on the first or second end surface, is about 3 μm or more and about 6 μm or less.

16. The multilayer ceramic capacitor according to claim 1, wherein
when a region around a boundary between the inner layer portion and the outer layer portion is defined as a boundary peripheral region, a relationship L2<L1<L3 is satisfied, wherein
L1 is a thickness of the outer electrode at the recess;
L2 is a thickness of the outer electrode at an end portion of the boundary peripheral region on a center side in the lamination direction of the inner layer portion; and
L3 is a thickness of the outer electrode at the center in the lamination direction.

17. The multilayer ceramic capacitor according to claim 1, wherein each of the outer electrodes is thicker at a corner portion of the inner layer portion than at an inner-layer peripheral boundary.

18. The multilayer ceramic capacitor according to claim 6, wherein
each of the outer electrodes includes an underlying electrode located on the first or second end surface and a plating layer located on the underlying electrode; and
when a region around a boundary between the inner layer portion and the outer layer portion is defined as a boundary peripheral region, a relationship L2<L1<L3 is satisfied; wherein
L1 is a thickness of the underlying electrode at the recess;
L2 is a thickness of the underlying electrode at an end portion of the boundary peripheral region on a center side in the lamination direction of the inner layer portion; and
L3 is a thickness of the underlying electrode at the center in the lamination direction.

19. The multilayer ceramic capacitor according to claim 6, wherein
when a region around a boundary between the inner layer portion and the outer layer portion is defined as a boundary peripheral region, a relationship L2<L1<L3 is satisfied; wherein
L1 is a thickness of the outer electrode at the recess;
L2 is a thickness of the outer electrode at an end portion of the boundary peripheral region on a center side in the lamination direction of the inner layer portion; and
L3 is a thickness of the outer electrode at the center in the lamination direction.
